(19) United States
(12) Patent Application Publication
(10) Pub. No.: US 2001/0014643 A1
(43) Pub. Date: Aug. 16, 2001

(54) Block formation system and method for controlling the folding of a block

(75) Inventor: Thomas Sander, Bielefeld (DE)

Correspondence Address: Barnes & Thornburg, Franklin Tower Bldg., Suite 500, 1401 Eye Street, N.W., Washington, DC, 20005, US

(73) Assignee: Gevas Verpackungsmaschinen GmbH

(21) Appl. No.: 09/778,933

(22) Filed: Feb. 8, 2001

(30) Foreign Application Priority Data
Feb. 10, 2000 (EP) PCT/EP00/01064

(51) Int. Cl. B31F 1/00

(52) U.S. Cl. 493/433

(57) ABSTRACT

A system for forming a block of folded material, and a method for folding material into a block. The system includes a folding mechanism, a lifting element receiving and supporting the block of folding material, a press acting on the block to compress an uppermost layer of the web material onto the block, a sensor detecting a degree of compression in the block, and an actuator capable of moving the the lifting element relative to the folding mechanism. The actuator moves the lifting element in response to the degree of compression in the block. The folding mechanism is made up of a pair of mutually parallel and counter-rotating cylinders between which the continuous web of material is fed. A grip and a pushing device are formed on each of the cylinders, and are are positioned such that as the cylinders rotate, the pushing device from one cylinder pushes material into the grip of the other.

### BACKGROUND AND SUMMARY OF THE INVENTION

The present invention pertains to a system for forming blocks of folded web material, preferably of nonwoven material or tissue. In the inventive system, a web of nonwoven material is fed through a folding device, which folds the web in a zigzag-like manner to form a block. The system also includes a press which acts on the block of folded material. The block is laid on a lifting element which is able to move relative to the folding means. The block forming system, such as the system disclosed herein, is generally known as “festooning”. The festooning process is common in making blocks of nonwoven materials, such as those used for hygienic articles.

Generally, hygienic goods are shipped from the suppliers to the end users in rolls. However, demands for more efficient production as well as the advent of thicker materials such as airlaid materials, have made the rolling process undesirable. Thus, an alternative method has developed—forming the materials in festooned blocks.

Festooning the material is a great improvement, because it reduces the amount of required handling and material. Because festooned blocks are generally more compact, festooning reduces material shipping and warehouse storage costs considerably. Additionally, festooning reduces the requirement for additional equipment to transport the materials to the production line. Also, festooned material runs more efficiently through high-speed converters.

U.S. Pat. No. 1,985,676 to Hand shows a method and an apparatus for folding a paper block from a continuous web of paper. As disclosed therein, paper is fed to an indenting mechanism providing folding lines in certain intervals. The folded material is received by helicoidal members assisting to obtain correct stacking of the folded sheets of band material. The folded block of material is arranged on a lifting table being movable in vertical direction, to keep the distance between the folding device and the upper surface of the block as constant as possible. Although this apparatus can produce festooned blocks, it has a complicated structure and is not suitable for high-speed applications.

European Patent Application EP 0 939 054 A2 discloses an apparatus for folding a continuous strip of material which uses a pair of cylinders, each cylinder having a means for deviating strip, and a means for gripping the strip in order to create a block of folded material. Each cylinder has a gripping means arranged on one side and a deviating means on the opposite side. In order to move the strip material from a position between the cylinders to the upper surface of the block, the gripping means clamps the strip material, then the cylinder rotates (by a figure less than 180°), and moves the material to the upper surface of the block of folded material.

Although this method may work for relatively light material, such as airlaid, the finished block is medium quality at best, and speed of forming the block is very limited. If the cylinders rotate at high speed, the material is not accurately laid. Additionally, if the cylinders contact the block, the upper surface of the block may become damaged, especially if the material is nonwoven, delicate fabric such as airlaid. Any type of contact with delicate fabric will likely result in tearing or deformation of the fabric. Commencing the fold is a particularly troublesome process. When starting the folding of a new block, the distance between the surface of the lifting element and the folding cylinders creates instability; the first layers tend to slip away, are not folded accurately and have to be discarded.

The present invention provides a block formation system and a method for controlling the folding of a block to allow high accuracy, even in the beginning of the folding process. Thus, the process avoids wasting the first layers of web material, and produces a block of folded material with high stability.

The invention is a block formation system for forming a block of folded material, preferably of nonwoven material or tissue. A web of woven material is passed through a folder, which folds the web material into a block. The invention further includes a press acting on the block, whereby the block is laid on a lifting element. A controller moves the lifting element in order to selectively adjust the of compression exerted on the block of folded material on the lifting element.

A feedback signal informs the controller of the relative degree of compression on the block. For example, if the compression is low, the controller may be instructed to increase the speed of the lifting element. In contrast, if the pressure on the block is exceeding a pre-determined value, the controller may be informed to reduce the speed. In this way, the pressure is maintained within a given range, allowing to obtain an optimised process in terms of stability, with very accurate and symmetric blocks.

Maintaining a physical pressure on the block assures a continuous contact between folding cylinders and uppermost material layer during block formation. As a result, a significant increase in the overall process speed is obtained.

The lifting element may have a flexible support device that allows a swinging movement of the lifting element. Such a “floating” support improves handling of the web material in the formation of the first few layers of the block. The movement of the lifting element in the beginning of the folding process allows the first layers to be accurately placed, which eliminates material damage and waste.

As soon as the first few layers are formed, sensors begin to detect buildup of pressure between the folder and the block surface. When the sensors detect a pressure of a predetermined level, the rocking mechanism of the lifting element ceases. Thereupon, the overall process speed can be increased during formation of the rest of the block.

Air cushion members may be incorporated in order to provide flexible support for the lifting element, which may also effectively damp unwanted vibrations. The flexible support device can become fixed after the first few layers of material are placed in order to avoid any further swinging movement of the lifting element.

In order to improve the handling of web material at the beginning of the block formation, a board may receive the lowermost portion of the web material. The board has a rough surface to frictionally engage the lowermost portion of the web material.

The press includes a measuring unit for detecting the degree of compression on the block, and a control unit analysing the data and comparing them to a pre-set optimum pressure, which is then used as a signal for adapting the speed for the vertical movement of the lifting element. The feedback of the control unit is immediate, so that the handling of the material is easily adaptable with respect to different material properties and thicknesses.

The above object is also solved by a method for controlling the folding of a block, comprising the steps of:

feeding web material to a folding device;

folding the web in a zigzag-like manner, thus building a block of folded material on a lifting element; whereby pressing means act on the uppermost web layer and the degree of compression is measured and used for controlling the relative movement of the lifting element with respect to the pressing means.

In a preferred embodiment of the method, the lifting element is allowed to swing in a perpendicular direction to the folding edges of the block in the beginning of the folding process, in order to improve the stability of the overall process even during folding the first layers. Additionally, high-speed operations benefit from an increasing pressure on the block, as this provides a damping effect to the material already folded.

Compression of the block is maintained within a given range in order to form a finished block with similar properties in upper and lower portions. Such a continuous compression can be achieved by two folders in the form of cylinders, each being provided with a press. The press comprises a set of fingers adjacent each cylinder. As the system is set in motion, one set of fingers presses on the block on one side while web material is laid down on the opposite side of the block. Meanwhile, sensors detect the pressure exerted on the top layer of the block, process this information to determine whether to automatically adjust the speed of the lifting table.

Other objects, advantages and novel features of the present invention will become apparent from the following detailed description of the invention when considered in conjunction with the accompanying drawings.

### BRIEF DESCRIPTION OF THE DRAWINGS

FIG. 1 shows a schematic drawing of the overall manufacturing method;

FIG. 2 shows a schematic side view of a first embodiment of the apparatus according to the present invention;

FIG. 3 shows a side view of the lifting element with a lower portion of the block, and

FIG. 4 shows an enlarged side view of the lifting element of FIG. 3.

### DETAILED DESCRIPTION OF THE PREFERRED EMBODIMENTS

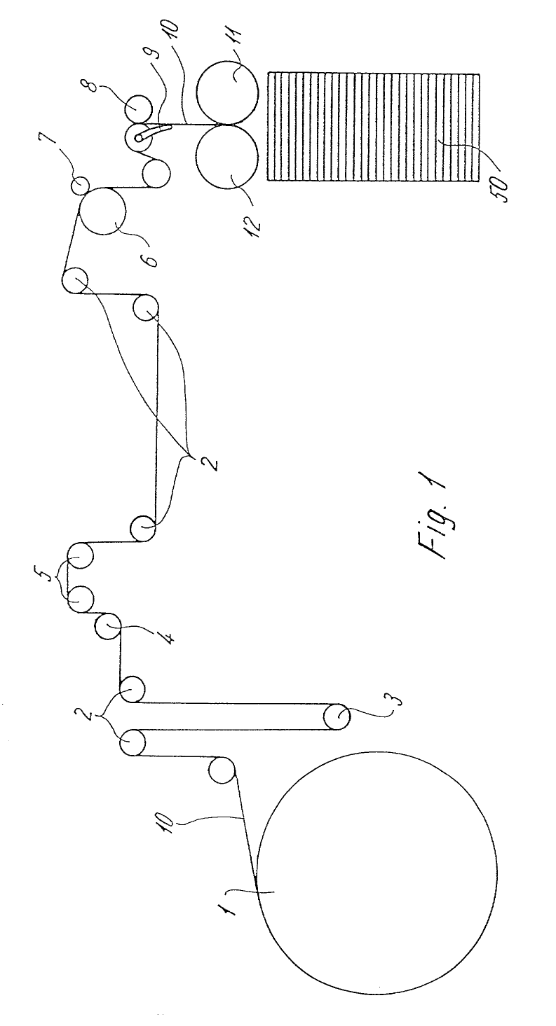

As shown in FIG. 1, a roll 1 of web material is delivered to the festooning system. The full width of the mother roll is unwound so that a web 10 is fed to the processing station.

The web 10 passes through a tension control system comprising two rollers 2 and a pneumatic dancing roller 3 being connected to a potentiometer to feedback the system on the dancing roller position. The tension control system assures process stability, since the quality of the festooning process is indexed to tension steadiness and avoidance of web elongation.

Then the web 10 passes through an automatic web-guiding device, tracking the web material 10 within narrow tolerances and thus controlling the position of the web in the slitting station. A standard pivoted tracking unit helps optimize the accurate alignment of the material.

Two photo cells, each featuring a large operating window optic for precise web detection as well as specially coated light-weight rollers ensure smooth handling of nonwoven materials. A control panel allows for manual adjustments during machine set-up.

When the festooner is used for multilane production, the material has to be slit into lanes of the required width. Slitting is achieved with unique crush cut perforations knives 7 that provide multiple width variation capabilities, depending on machine configuration. The slitters are pneumatically loaded with a constant and uniform slit pressure against an anvil roll 6. The slitting system includes a precise S-wrap material metering system. The edges of the lanes are also trimmed here, which keeps waste to a minimum.

After slitting the web fabric into lanes, the web 10 is guided between two rolls 8 having another tension control system 9. The tension control system 9 comprises a lever with a roll pressing against the web 10 to assure constant web tension. The web 10 is then fed to the folder—two folding cylinders 11 and 12—to build a block 50 of folded material.

The block 50 is arranged on a lifting element 24, which is moved downwards during the festooning process as the block 50 gets thicker. As soon as the required thickness of the material block 50 is reached, the block 50 is removed from the lifting element 24, and a new block 50 is begun.

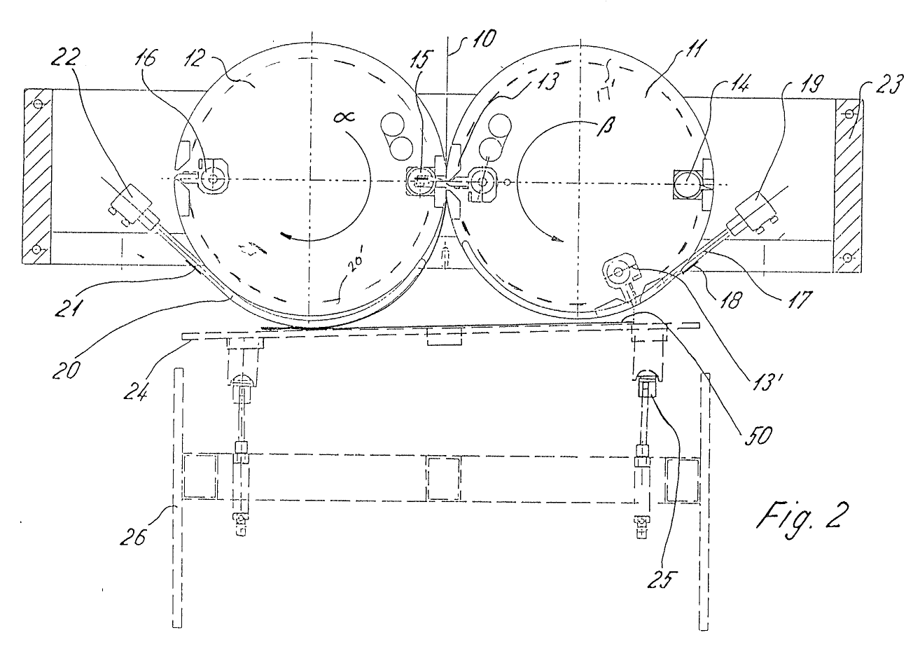

FIG. 2 shows the folding of the web 10 by the folding cylinders 11 and 12. The web 10 should have a constant level of tension. The web 10 is fed through a gap between the cylinders 11 and 12. Each folding cylinder 11 and 12 has a gripping means 13 and 16, and a pushing means 14 and 15. A swinging set of fingers 17 is mounted on a holder 19 below the cylinder 11. The fingers 17 comprise a measuring means 18 which detects the actual pressure of the fingers 17 on the material block 50 during the festooning process. On the opposite side, another set of fingers 20 is mounted to a holder 22, each finger having a measuring means 21 to detect pressure of the fingers 20 on the material block 50.

The folding cylinders 11 and 12 as well as the holders 19 and 22 are mounted to a frame 23. Below the frame 23, a movable lifting element 24 receives the block 50. The lifting element 24 is arranged on a pneumatic system 25 that allows the element 24 to rock, move and sway while the first block layers are formed in order to maintain a continuous contact between the lifting element 24 and the material web 10. The pneumatic system 25 is mounted to a lifting frame 26, and movable together with the lifting element 24.

The steps of the inventive method of folding the material into a block are described with reference to FIG. 2.

The method is primarily is a cyclical process. Counter-rotating cylinders 11 and 12 are used as folding elements. Each of these cylinders 11 and 12 alternate between an operative and a non-operative position. Their respective directions of rotation are indicated by arrows a and b. Each rotation of the cylinder forms two layers of the block 50.

As material is fed into the folding mechanism, the web material 10 is pushed to a grip 13 mounted in cylinder 11. The grip 13 comprises a gripping element being pivoted around an axis. The gripping element is mounted to a holding member which is biased by a cam. Accordingly, the holding member is biased to a closed position. In order to clamp the web 10 between the gripping element and a receiving element mounted in the folding cylinder 11, the pushing element 15 tucks a portion of the web 10 between the gripping element and the receiving element.

The grip 13 is cam-driven, and opens and closes in response to changes in the angular position of the cylinder 11. Preferably, the grips 13, 16 and the pushers 14, 15 are cooperatively placed on the cylinders 11, 12 so that they meet when the cylinders are rotated in a parallel and opposite manner.

Before reaching the position where the grip 13 and the pusher 15 are adjacent, the grip 13 opens to receive a portion of the web 10, and clamps onto it using the gripping element and the receiving element. The grip 13 then closes, and the web 10 is carried along the circumference of the cylinder to an angular position of about 120°. At approximately this position, the grip 13 opens to release the web 10. Then, the folding cylinder 11 continues to rotate another 60° approximately. At this point, the pusher 14 tucks the web 10 to the grip element 16 on cylinder 12. The grip 16 grips and carries the web 10 along the circumference of the cylinder for approximately 120° before grip 16 opens to release the web 10.

Once the cylinders rotate another 60°, the folding cylinders 11 and 12 are in their respective original positions, as shown in FIG. 2. Thereupon, the cyclical process starts over again.

The cylinders 11 and 12 are equipped with circumferential recesses 17′ and 20′, respectively. As shown in FIG. 2, the fingers 17 slide within the circumferential recesses 17′ of cylinder 11 while the web 10 transfers to grip 13 of cylinder 11. As the web 10 is carried by grip 13, the fingers 17 remain in the recess 17′.

Meanwhile, the fingers 20 press on the block 50 of folded material. In the position shown in FIG. 2, the fingers 17 are in a rest position between ribs integrated in the folding cylinder 11. When the gripping means 13 has moved about 120°, the grip 13 opens and releases a clamped portion of the web 10. Then, the fingers 17 are pivoted around the holder 19 in order to press on the uppermost layer of web material on the block 50. Thus, the web 10 being moved along the folding cylinder 11 with high speed can be stopped abruptly in order to put down each layer of web material in an accurate position.

As the fingers 17 are pressing on the block 50, a new portion of web material 10 is fed between the folding cylinders 11 and 12 until the pusher 14 presses a portion of the web 10 to the grip 16 of cylinder 12. Then cylinder 12 rotates and carries the gripped portion of the web 10 around the fingers 20, which are, at this time, positioned within the circumferential recesses 20′. Meanwhile, the fingers 17 are pressing on the block 50.

When the grip 13 releases the web 10, the fingers 20 press on the block 50, while the fingers 17 are in their circumferential recesses 17′.

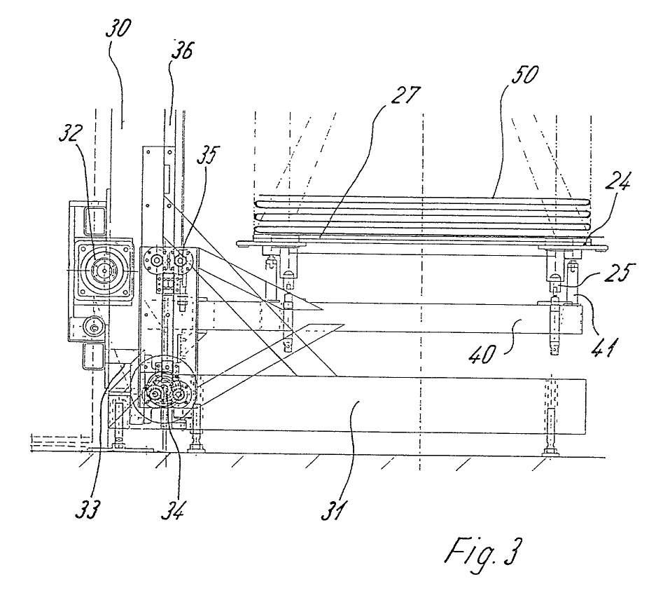

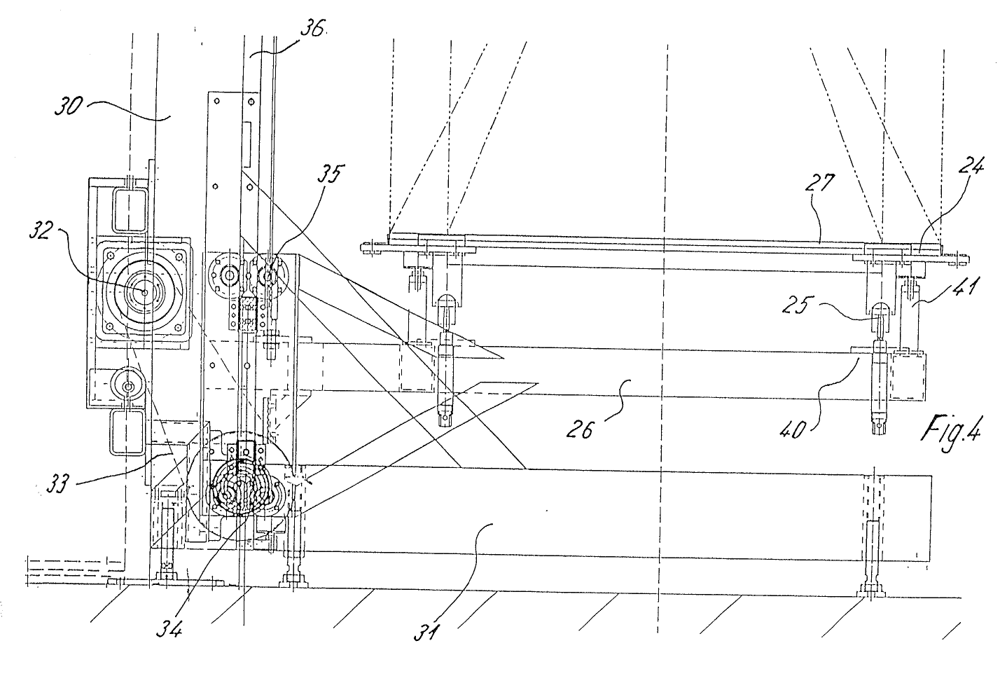

FIGS. 3 and 4 show the lifting element 24 and its driving mechanism. The lifting element 24 supports a board 27 having a rough surface which frictionally engages the lowermost layer of web material 10 of the block 50 and the board 27, so that during folding of the lower portion of the block 50 the web material 10 cannot slip away.

The driving mechanism of the lifting element 24 comprises a control unit (not shown) for controlling a motor 32, which is driving a lifting frame 26 via a transmission band 33. The lifting frame 26 vertically moves the lifting element 24 during the folding process. Rollers 35 guide the lifting apparatus 34 on a rail 30 by contacting a guide element 36 of the rail 30. The driving mechanism may comprise toothed wheels and other appropriate means for transmitting the driving force of the motor 32 to the lifting element 24.

The lifting frame 26 drives a holder 40 supporting the lifting element 24 with a floating mechanism. Four cylinders with air cushion members 25 are provided on the holder 40. The air cushion members 25 provide vibration-absorbing support for the lifting element 24. The air cushion members 25 are lockable in order to fix the lifting element 24 to the holder 40. In the lower position, the lifting element 24 is positioned on support members 41 and connected with the holder 40.

During the festooning of the web 10 into a block 50 of folded material, the degree of compression may be measured by wire strain gauge elements 18 and 21, respectively. The detected degree of pressure on the block 50 is relayed to a control unit, which analyzes and compares the data to a pre-set optimum pressure. For example, if the detected pressure on the block 50 is too high, the control unit sends a signal to increase the speed of the lifting element 24. If the pressure on the block 50 is too low, the control unit sends a signal to decrease the speed of the lifting element 24.

Accordingly, the pressure on the block 50 can be maintained within a given range during the festooning process. It is also possible to adjust the degree of compression in relation to the height of the block 50, i.e. the higher the block 50, the higher the pressure on the block 50.

After festooning of the block 50, the web 10 can be cut before transporting the block 50 to another station. It is also possible to move the block 50 to a rest station and to festoon another block so that the block 50 and the other block are linked by a continuous portion of web material.

Although the present invention has been described and illustrated in detail, it is to be clearly understood that the same is by way of illustration and example only, and is not to be taken by way of limitation. The spirit and scope of the present invention are to be limited only by the terms of the appended claims.

I claim:

1. A system for forming a block of folded material, comprising:
a folding means between which web material is passed for folding the web material into a block;
a pressing means for pressing layers of the web material into a block;
a lifting element receiving and supporting the block;
a moving means for moving the lifting element relative to the folding means; and
a controlling means for controlling the moving means as a function of degree of compression in the block.

2. A system according to claim 1, further comprising a flexible support device supporting the lifting element, thereby allowing a swinging movement of the lifting element.

3. A system according to claim 2, wherein the flexible support device comprises air cushion members which supports the lifting element.

4. A system according to claim 2, wherein the flexible support device may be fixed in order to prevent swinging movement of the lifting element.

5. A system according to claim 1, further comprising a board positioned on the lifting element to receive a lowermost portion of the web material.

6. A system according to claim 5, further comprising a rough surface on the board, the rough surface positioned to frictionally engage the lowermost portion of the web material.

7. A system according to claim 1, wherein the lifting element is a flat surface with holding elements to receive a board.

8. A system according to claim 1, wherein the pressing means includes a measuring unit for measuring compression on the block.

9. A system according to claim 8, wherein the control means receives data from the measuring unit and provides a signal to the moving means for controlling the vertical movement of the lifting element.

10. A method for controlling the folding of material into a block, comprising the steps of:
feeding web material to a folding device;
folding the web material in a zigzag manner, thus building a block of folded material on a lifting element;
compressing an uppermost web layer onto the lifting element with a press;
measuring a degree of compression in the block; and
controlling relative movement of the lifting element with respect to the press based upon the measured degree of compression.

11. The method according to claim 10, further comprising the step of swinging the lifting element in a direction perpendicular to folding edges of the web material when the method is begun.

12. The method according to claim 10, further comprising the step of maintaining the degree of compression within a preselected range.

13. The method according to claim 10, wherein two folding cylinders fold the web material, each cylinder having a pressing means, and one pressing means acts to compress the block on one side while web material is laid down by a folding cylinder on an opposite side of the block.

14. The method according to claim 10 further comprising the step of laying a board on the lifting element before the method is begun.

15. Method according to claim 14, further comprising the step of transporting the board and the block together as a package unit.

16. A system for forming a block of folded material, comprising:
a folding mechanism which folds a continuous web of material into a block, the folding mechanism including
a pair of mutually parallel and counter-rotating cylinders between which the continuous web of material is fed,
a grip formed on each of the cylinders,
a pushing device formed on each of the cylinders, the grips and pushing devices are positioned such that as the cylinders rotate,
the pushing device from one cylinder pushes material into the grip of the other;
a lifting element receiving and supporting the block;
a press acting on the block to compress an uppermost layer of the web material onto the block;
a sensor detecting a degree of compression in the block; and
an actuator capable of moving the the lifting element relative to the folding mechanism in response to the degree of compression in the block.

17. A system according to claim 16, further comprising at least one circumferential recess formed on each of the cylinders; and wherein, the press comprises at least one finger formed to fit within the ridges.

18. A system according to claim 16, further comprising a flexible support device supporting the lifting element, thereby allowing a swinging movement of the lifting element.

19. A system according to claim 18, the flexible support device comprising air cushion members which supporting the lifting element.

20. A system according to claim 16, wherein the flexible support device may be fixed in order to prevent swinging movement of the lifting element.

21. A system according to claim 16, further comprising a board positioned on the lifting element to receive a lowermost portion of the web material.

22. A system according to claim 21, the board having a rough surface positioned to frictionally engage the lowermost portion of the web material.

23. A system according to claim 16, wherein the lifting element is a flat surface with holding elements to receive a board.

24. A system according to claim 16, wherein the sensor and the press are integrally formed.

25. A system according to claim 16 further comprising a control unit in communication with the sensor; wherein the control unit receives data from the sensor, then transmits a signal to the actuator in order to move the lifting element.
